(19) United States
(12) Patent Application Publication
(10) Pub. No.: US 2014/0040430 A1
(43) Pub. Date: Feb. 6, 2014

(54) Method and device for pushing internet information based on categorization, and computer storage medium

(71) Applicant: TENCENT TECHNOLOGY (SHENZHEN) COMPANY LIMITED, GUANGDONG (CN)

(72) Inventors: Yu Fan, Shenzhen (CN); Junjun Yao, Shenzhen (CN); Yingjie Wo, Shenzhen (CN); Qingling Yan, Shenzhen (CN); Cong Wang, Shenzhen (CN)

(21) Appl. No.: 14/051,388

(22) Filed: Oct. 10, 2013

Related U.S. Application Data
(63) Continuation of application No. PCT/CN2012/077887, filed on Jun. 29, 2012.

(30) Foreign Application Priority Data
Sep. 9, 2011 (CN) 201110268256.7

(51) Int. Cl. H04L 29/08

(52) U.S. Cl. CPC H04L 67/26
USPC 709/217

(57) ABSTRACT

It is disclosed a method and device for pushing internet information based on categorization, and a computer storage medium. The method includes the following steps: when receiving a service request initiated by a micro-blog user, a server selects (101), for the micro-blog user, a list of recommended micro-blog celebrities that fall into a same category as a micro-blog celebrity already listened to by the micro-blog user; and the server feeds (102) information of the selected micro-blog celebrities back to the micro-blog user. The present disclosure can effectively push specific user categorizing information, and enhance willingness of the user to participate network information interaction, thereby increasing the level of activity of the user in participating network information interaction. Moreover, with the method for pushing internet information based on categorization, more internet information of the same category can be listened to, forming a beneficial and valuable relation chain, thereby further increasing the level of activity of the user in participating internet information interaction.

### CROSS REFERENCE TO RELATED APPLICATIONS

This is a continuation application of International Patent Application No.: PCT/CN2012/077887, filed on Jun. 29, 2012, which claims priority to Chinese Patent Application No.: 201110268256.7, filed on Sep. 9, 2011, the disclosure of which is incorporated by reference herein in its entirety.

### TECHNICAL FIELD

The disclosure relates to the field of computer technology, and in particular to a method and device for pushing internet information based on categorization, and a computer storage medium.

### BACKGROUND

Micro-blog is a platform for sharing, disseminating, and acquiring information based on a user relationship, where a user may build a personal community through an internet (WEB) or a Wireless Application Protocol (WAP), or other various clients, update information with about 140 words, and achieve instant sharing. The micro-blog is highly prevalent among users due to its characteristics such as simplicity and easiness in use, low threshold of technical requirement to the user, and access terminal diversity, and has achieved rapid development.

In a micro-blog system, as long as a first user sets to “listen to” a second user, it means that the first user is willing to receive instantly updated information of the second user, and the micro-blog system will present micro-blog information released by the second user the first user (also called the subscriber) has listened to, to the subscriber through a variety of ways.

A major feature of the micro-blog is that it gathers in its users a large number of famous people from all walks of life or well-known enterprises and institutions (For simplicity, referred to as micro-blog celebrities hereinafter), that an ordinary user may interact with the micro-blog celebrities conveniently through the micro-blog. In order to enable the ordinary user to find the micro-blog of micro-blog celebrities more conveniently, an existing micro-blog system usually provides a function for recommending micro-blog celebrities. However, the existing micro-blog system generally recommends a celebrity micro-blog to the user randomly, according to statistics of visits, or by background manual editing. It is likely that the celebrity micro-blog recommended by the micro-blog system is not the one preferred or cared by the user, and the micro-blog system is unable to make a targeted delivery according to a categorization of the user, and is therefore unable to satisfy a user requirement at a present stage.

### SUMMARY

In view of the above, an embodiment of the present disclosure provides a method and device for pushing internet information based on categorization as well as a computer storage medium for solving the technical problem that an existing micro-blog system cannot implement recommendation of a celebrity micro-blog based on user categorization.

A method for pushing internet information based on categorization includes:

when receiving a service request initiated by a micro-blog user, a server selects for the micro-blog user a list of recommended micro-blog celebrities that fall into a same category as a micro-blog celebrity already listened to by the micro-blog user, and feeds the list of recommended micro-blog celebrities back to the micro-blog user.

Based on one aspect of an embodiment of the present disclosure, an embodiment of the present disclosure also provides a device for pushing internet information based on categorization, including:

a selecting module configured to select, when receiving a service request initiated by a micro-blog user, for the micro-blog user, a list of recommended micro-blog celebrities that fall into a same category as a micro-blog celebrity already listened to by the micro-blog user; and
a feedback module configured to feed the list of recommended micro-blog celebrities back to the micro-blog user.

Based on one aspect of an embodiment of the present disclosure, an embodiment of the present disclosure also provides a computer storage medium in which a computer program is stored, wherein the computer program is used for implementing the above mentioned method for pushing internet information based on categorization.

An embodiment of the present invention can provide an effective list of recommended micro-blog celebrities of a specific category, enhance willingness of the user to participate a micro-blog activity, thereby increasing the level of activity of the user in participating the micro-blog. Moreover, with the method for recommending micro-blog celebrities based on categorization, more micro-blog celebrities of the same category can be listened to, forming a beneficial and valuable relation chain, thereby further increasing the level of activity of the user in participating the micro-blog.

### BRIEF DESCRIPTION OF THE DRAWINGS

FIG. 1 is a flow chart of a method for pushing internet information based on categorization according to an embodiment of the disclosure; and

FIG. 2 is a schematic view of the structure of a device for pushing internet information based on categorization according to an embodiment of the disclosure.

### DETAILED DESCRIPTION

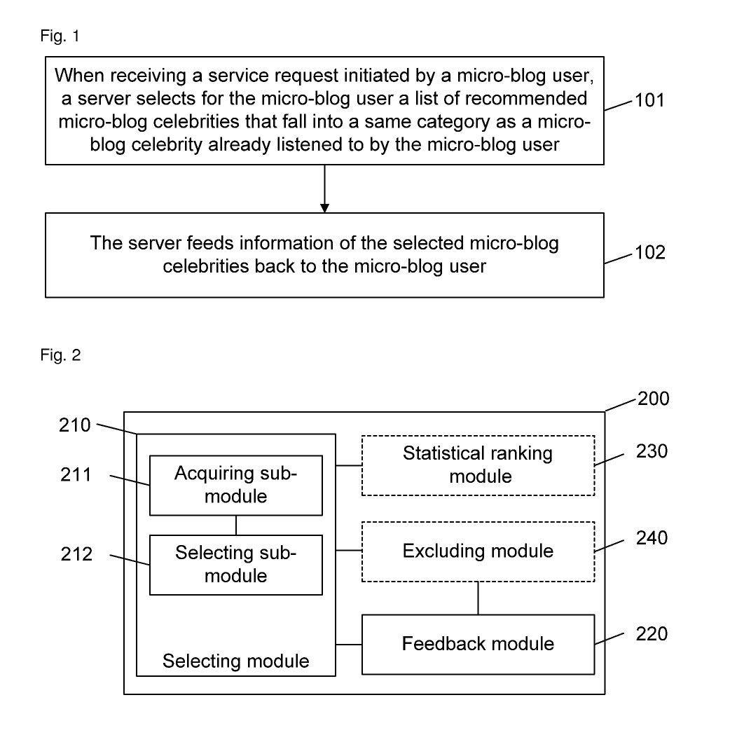

FIG. 1 is a flow chart of a method for pushing internet information based on categorization according to embodiment of the disclosure. The method includes the following steps.

Step 101: when receiving a service request initiated by a micro-blog user, a server selects for the micro-blog user a list of recommended micro-blog celebrities that fall into a same category as a micro-blog celebrity already listened to by the micro-blog user.

In an embodiment of the disclosure, a category is set for a micro-blog celebrity at the server, where each micro-blog celebrity falls into at least one category.

After one micro-blog user listens to one micro-blog celebrity, a listening-to relationship of the micro-blog user is saved at the server. When receiving the service request initiated by the micro-blog user, the server first acquires a user identifier of the micro-blog user initiating the request, and then retrieves the listening-to relationship of the micro-blog user via the user identifier. When it is determined that the micro-blog user has listened to a micro-blog celebrity, the server acquires the category of the micro-blog celebrity already listened to by the micro-blog user, and then selects for the micro-blog user the list of recommended micro-blog celebrities that fall into the same category as the micro-blog celebrity already listened to by the micro-blog user.

The selection of the list of recommended micro-blog celebrities is based on category statistics performed on the micro-blog celebrities by the server. The server provides, for each category of micro-blog celebrities, a statistical ranking, the basis of which may be quantity of listening-tos, quantity of visits and the like.

The method for selecting the list of recommended micro-blog celebrities is that:

(1) the category of the micro-blog celebrity listened to by the micro-blog user initiating the service request is acquired; and

(2) some top-ranked micro-blog celebrities are selected as the list of recommended micro-blog celebrities from a result of statistical ranking of the micro-blog celebrities whose category is the same as the category of the micro-blog celebrities listened to by the micro-blog user.

In order to embody fairness, the selected list of recommended micro-blog celebrities in the embodiment of the present disclosure should include some lower-ranked micro-blog celebrities. This is to be achieved with a certain algorithm. For example, assuming that 10 micro-blog celebrities are to be recommended to a terminal, 5 micro-blog celebrities are first selected from the top 30 micro-blog celebrities, then the other 5 micro-blog celebrities are randomly selected from the micro-blog celebrities ranked below 30, and a set consisting of micro-blog celebrities selected from the two parts are fed back to the micro-blog user initiating the service request as the list of recommended micro-blog celebrities.

Step 102: the server feeds the list of recommended micro-blog celebrities back to the micro-blog user initiating the service request.

Preferably, the server may feed the list of recommended micro-blog celebrities, together with a service response, back to the micro-blog user initiating the service request.

Preferably, before feeding the list of recommended micro-blog celebrities back to the micro-blog user initiating the service request, a step of excluding, from the list of recommended micro-blog celebrities, the micro-blog celebrity already listened to by the micro-blog user is also included. This step may prevent a repetitive listening-to of the micro-blog user.

FIG. 2 is a structural view of functional modules of a device for pushing internet information based on categorization according to an embodiment of the disclosure. The device 200 includes:

a selecting module 210 configured to select, when receiving a service request initiated by a micro-blog user, for the micro-blog user, a list of recommended micro-blog celebrities that fall into a same category as a micro-blog celebrity already listened to by the micro-blog user; and
a feedback module 220 connected to the selecting module 210 and configured to feed the list of recommended micro-blog celebrities back to the micro-blog user.

Preferably, the feedback module 220 may feed the list of recommended micro-blog celebrities, together with a service response, back to the micro-blog use.

Preferably, the device 200 also includes:

a statistical ranking module 230 connected to the selecting module 210 and configured to carry out a statistical ranking of micro-blog celebrities of a same category.

The result of the statistical ranking output by this module is used by the selecting module 210 in selecting the list of recommended micro-blog celebrities for the micro-blog user.

Preferably, the selecting module 210 further includes:

an acquiring sub-module 211 configured to acquire the category of the micro-blog celebrity listened to by the micro-blog user; and
a selecting sub-module 212 connected to the acquiring sub-module 211 and configured to select some top-ranked micro-blog celebrities as the list of recommended micro-blog celebrities, or select some top-ranked micro-blog celebrities plus some randomly selected lower-ranked micro-blog celebrities as the list of recommended micro-blog celebrities from a result of statistical ranking of micro-blog celebrities whose category is the same as the category of the micro-blog celebrity listened to by the micro-blog user in the statistical ranking module 230.

Preferably, the device 200 also includes:

an excluding module 240 connected to the selecting module 210 and the feedback module 220, and the excluding module 240 is configured to exclude from the list of recommended micro-blog celebrities, the micro-blog celebrity already listened to by the micro-blog user before the list of recommended micro-blog celebrities is fed back to the micro-blog user.

The excluding module 240 acquires the list of recommended micro-blog celebrities from the selecting module 210, and transmits the filtered list of recommended micro-blog celebrities to the feedback module 220 after filtering the list of recommended micro-blog celebrities.

An integrated module according to an embodiment of the present disclosure may also be stored in a computer readable storage medium if it is implemented in the form of a software function module and is sold or employed as an independent product. Based on such understanding, the technical solution of the embodiment of the present disclosure may be embodied in the form of a software product essentially or for the part contributing to the prior art. The computer software product is stored in a storage medium and includes a number of instructions for allowing computer equipment (such as a personal computer, a server, network equipment, or the like) to implement all or part of the method described in various embodiments of the present disclosure. The aforementioned storage medium includes various media that may store program codes, such as USB disk, mobile hard disk, ROM (Read-Only Memory), RAM (Random Access Memory), diskette, or compact disk, etc. An embodiment of the present disclosure is not limited to any specific hardware and software combination.

Accordingly, an embodiment of the present disclosure also provides a computer storage medium in which a computer program is stored, wherein the computer program is used for implementing the method for pushing internet information based on categorization according to an embodiment of the present disclosure.

What described are merely preferred embodiments, and are not intended to limit the scope of the present disclosure.

1. A method for pushing internet information based on categorization, comprising:
when receiving a service request initiated by a micro-blog user, selecting, by a server, for the micro-blog user, a list of recommended micro-blog celebrities that fall into a same category as a micro-blog celebrity already listened to by the micro-blog user, and feeding, by the server, the list of recommended micro-blog celebrities back to the micro-blog user.

2. The method according to claim 1, wherein the feeding the list of recommended micro-blog celebrities back to the micro-blog user comprises:
feeding the list of recommended micro-blog celebrities, along with a service response, back to the micro-blog user.

3. The method according to claim 1, further comprising: before receiving the service request,
setting a category for a micro-blog celebrity, and carrying out a statistical ranking of micro-blog celebrities which are in a same category.

4. The method according to claim 3, wherein the selecting for the micro-blog user a list of recommended micro-blog celebrities that fall into a same category as a micro-blog celebrity already listened to by the micro-blog user comprises:
acquiring the category of the micro-blog celebrity listened to by the micro-blog user; and
selecting some top-ranked micro-blog celebrities as the list of recommended micro-blog celebrities, or selecting some top-ranked micro-blog celebrities plus some randomly selected lower-ranked micro-blog celebrities as the list of recommended micro-blog celebrities from a result of statistical ranking of micro-blog celebrities whose category is the same as the category of the micro-blog celebrity listened to by the micro-blog user.

5. The method according to claim 4, further comprising: before feeding the list of recommended micro-blog celebrities back to the micro-blog user,
excluding, from the list of recommended micro-blog celebrities, the micro-blog celebrity already listened to by the micro-blog user.

6. A device for pushing internet information based on categorization, comprising:
a selecting module configured to select, when receiving a service request initiated by a micro-blog user, for the micro-blog user, a list of recommended micro-blog celebrities that fall into a same category as a micro-blog celebrity already listened to by the micro-blog user; and
a feedback module configured to feed the list of recommended micro-blog celebrities back to the micro-blog user.

7. The device according to claim 6, wherein the feedback module is configured to feed the list of recommended micro-blog celebrities, along with a service response, back to the micro-blog user.

8. The device according to claim 6, further comprising:
a statistical ranking module connected to the selecting module and configured to carry out a statistical ranking of micro-blog celebrities of a same category.

9. The device according to claim 8, wherein the statistical ranking module comprises:
an acquiring sub-module configured to acquire the category of the micro-blog celebrity listened to by the micro-blog user; and
a selecting sub-module configured to select some top-ranked micro-blog celebrities as the list of recommended micro-blog celebrities, or select some top-ranked micro-blog celebrities plus some randomly selected lower-ranked micro-blog celebrities as the list of recommended micro-blog celebrities from a result of statistical ranking of micro-blog celebrities whose category is the same as the category of the micro-blog celebrity listened to by the micro-blog user in the statistical ranking module.

10. The device according to claim 9, further comprising:
an excluding module connected to the selecting module and the feedback module, the excluding module being configured to exclude from the list of recommended micro-blog celebrities, the micro-blog celebrity already listened to by the micro-blog user before the list of recommended micro-blog celebrities is fed back to the micro-blog user.

11. A computer storage medium storing a computer program configured to implement the method according to any one of claim 1.

12. The method according to claim 2, further comprising: before receiving the service request,
setting a category for a micro-blog celebrity, and carrying out a statistical ranking of micro-blog celebrities which are in a same category.

13. The method according to claim 12, wherein the selecting for the micro-blog user a list of recommended micro-blog celebrities that fall into a same category as a micro-blog celebrity already listened to by the micro-blog user comprises:
acquiring the category of the micro-blog celebrity listened to by the micro-blog user; and
selecting some top-ranked micro-blog celebrities as the list of recommended micro-blog celebrities, or selecting some top-ranked micro-blog celebrities plus some randomly selected lower-ranked micro-blog celebrities as the list of recommended micro-blog celebrities from a result of statistical ranking of micro-blog celebrities whose category is the same as the category of the micro-blog celebrity listened to by the micro-blog user.

14. The method according to claim 13, further comprising: before feeding the list of recommended micro-blog celebrities back to the micro-blog user,
excluding, from the list of recommended micro-blog celebrities, the micro-blog celebrity already listened to by the micro-blog user.

15. The device according to claim 7, further comprising:
a statistical ranking module connected to the selecting module and configured to carry out a statistical ranking of micro-blog celebrities of a same category.

16. The device according to claim 15, wherein the statistical ranking module comprises:
an acquiring sub-module configured to acquire the category of the micro-blog celebrity listened to by the micro-blog user; and
a selecting sub-module configured to select some top-ranked micro-blog celebrities as the list of recommended micro-blog celebrities, or select some top-ranked micro-blog celebrities plus some randomly selected lower-ranked micro-blog celebrities as the list of recommended micro-blog celebrities from a result of statistical ranking of micro-blog celebrities whose category is the same as the category of the micro-blog celebrity listened to by the micro-blog user in the statistical ranking module.

17. The device according to claim 16, further comprising:
an excluding module connected to the selecting module and the feedback module, the excluding module being configured to exclude from the list of recommended micro-blog celebrities, the micro-blog celebrity already listened to by the micro-blog user before the list of recommended micro-blog celebrities is fed back to the micro-blog user.
